(19) United States
(12) Patent Application Publication
(10) Pub. No.: US 2002/0169615 A1
(43) Pub. Date: Nov. 14, 2002

(54) Computerized voice-controlled system for compiling quality control data

(76) Inventors: Irwin Kruger, New York, NY (US); Nathaniel R. Gold, Fremont, CA (US)

Correspondence Address: PENNIE & EDMONDS LLP, 1667 K STREET NW, SUITE 1000, WASHINGTON, DC, 20006

(21) Appl. No.: 10/098,458

(22) Filed: Mar. 18, 2002

Related U.S. Application Data
(60) Provisional application No. 60/277,937, filed on Mar. 23, 2001.
(60) Provisional application No. 60/284,198, filed on Apr. 18, 2001.

(51) Int. Cl. G10L 21/00

(52) U.S. Cl. 704/270.1

(57) ABSTRACT

A system and method for reporting quality control information using speech recognition technology permits an inspector in the field to report information by a telephone. The inspector interacts with a voice-based interactive system to specify such things as the facility at which an inspection is being performed, the categories of items that are being evaluated, and various attributes regarding each item being evaluated. The system can subsequently use the information input by the inspector to generate inspection reports and send notifications of and/or copies of reports to various reviewers.

### RELATED APPLICATIONS

This application claims priority to U.S. Provisional application No. 60/277,937, filed Mar. 23, 2001 and to U.S. Provisional application No. 60/284,198, filed Apr. 18, 2001.

### FIELD OF THE INVENTION

The present invention relates to a system and method for collecting quality control information of remote inspection sites and then generating and distributing a report via a variety of communication means. It is particularly directed to a system for voice reporting of quality control information through a speech recognition system from the field by an inspector charged with monitoring quality at one or more facilities, where the quality control information is compiled into a final report accessible via the Internet.

### BACKGROUND OF THE INVENTION

The prior art includes limited-vocabulary speech recognition systems that are capable of processing speech from multiple speakers whose voices have not previously been encountered. Such systems are used in telephony for directory assistance and retrieval of other information. Another example of a prior art is U.S. Pat. No. 6,023,697 which is directed to a speech-enabled system for assisting a user in interacting with a relational database.

### SUMMARY OF THE INVENTION

The present invention is directed to a system for collecting quality control information about a facility or facilities from one or more inspectors through a voice-based interactive system to a central Web server. The information is then compiled into a formatted report that may be distributed to one or more reviewers via the Internet. Also the reviewers may access the report via the Internet using an Internet browser. Alternatively, or in addition, the report may be distributed to reviewers via a variety of communication methods that includes wired as well as wireless technologies. These communication methods may not necessarily involve the Internet. Such a system may include an integrated voice service platform (IVSP) server and an application server. The IVSP server manages the front end of the system and provides the voice-based interface for inspectors and reviewers. The application server manages the back end of the system and may house the applications and other software tools that execute various functions relating to the collecting, generating, and distributing of the quality control information.

In a typical implementation of the system of the invention, a facility may be any place that is subject to a quality control inspection. Some illustrative examples of facilities where the system of this invention may be applied include restaurants, hospitals, amusement parks, retail facilities such as supermarkets, stores and even entire malls, call centers, warehouses, and also government facilities such as libraries, schools, motor vehicle departments, courts, military bases, administrative offices, and the like. An inspector may be a person who visits a facility to conduct a quality control inspection and submits a report via a telephone or other voice communication device. A reviewer may be a person or persons who examines the contents of one or more quality control inspection reports. In general, reviewers may work on behalf of entities that are interested in the performance of a facility. Thus, reviewers may include the inspectors, managers and other employees of the facility inspected, facility owners, facility operators, facility franchisers, and anyone who has been authorized to examine the quality control inspection reports. Inspectors also may be reviewers, at least for the purpose of examining the inspection reports that they themselves have generated or reports generated by others.

The present invention is also directed to a method for collecting quality control information over a telephone network and generating reports based on this information. The method calls for receiving a phone call from an inspector in the field, using a voice-based interactive system to receive information from the inspector, storing the received information in a database, and generating reports using the information received, where the reports may be distributed through the Internet or made available for accessing through the Internet.

The present invention is also directed to a computer readable medium having executable code stored thereon which is configured to carry out the various functionalities. During operation, the executable code may, but need not necessarily, reside on a single platform.

### BRIEF DESCRIPTION OF THE DRAWINGS

The present invention is described in detail below with reference to the drawings in which:

FIG. 1 illustrates the system according to the invention;

FIG. 2 illustrates the components of an IVSP server;

FIG. 3 illustrates the function of the application server system according to the invention;

FIGS. 4a & 4b are flowcharts for using a system in accordance with a preferred embodiment of the invention; and

FIG. 5 depicts an example of an inspection report in the form of an Internet Web page that may be generated based on the quality control information.

### DETAILED DESCRIPTION OF THE INVENTION

The contents of U.S. Pat. No. 6,023,697 are incorporated by reference to the extent necessary to understand the present invention.

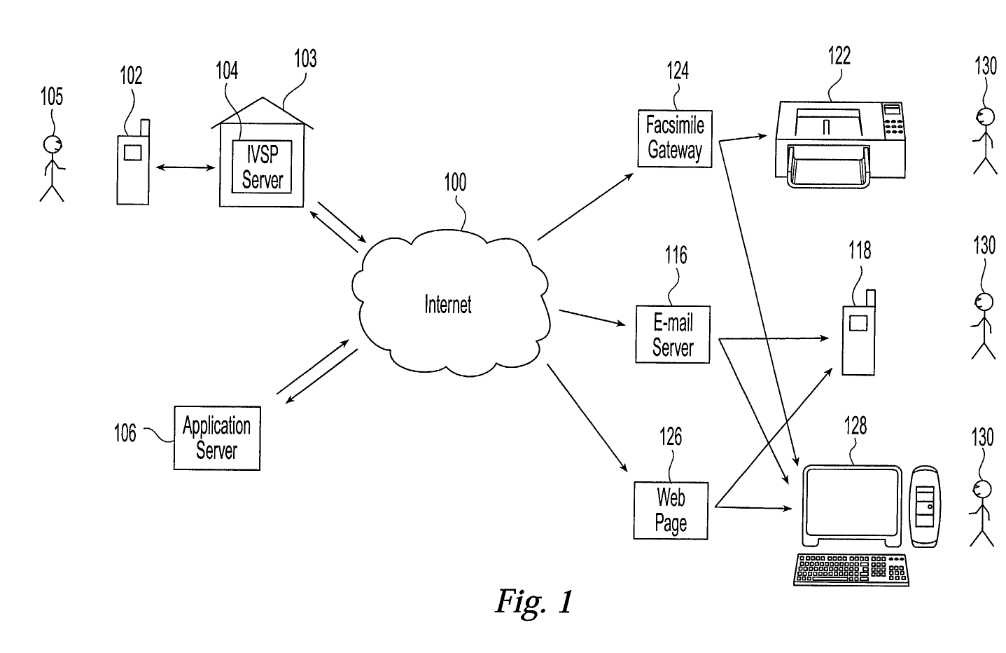

FIG. 1 represents an architectural overview of a preferred embodiment of a system for collecting and distributing quality control information through a voice-based interactive system to a central Web server. For the purpose of this discussion, a caller 105 may be a person who calls the voice-based interactive system to either report or review quality control information. In other words, the caller may be an inspector or a reviewer and will be interchangeably referred to as a caller, an inspector, or a reviewer throughout this discussion.

To submit a report, an inspector 105 calls a designated voice reporting service center 103 using any landline, cellular or other mobile telephone 102, or the like. Preferably, the designated voice reporting service center may be accessible via a toll-free telephone number for ease of use. Voice reporting service center 103 preferably would be equipped with an IVSP server 104, a voice-based interactive system capable of speech recognition and speech synthesis for interacting with the inspector and recording and reporting of the inspection data. Throughout the voice-based interactive session with inspector 105, IVSP server 104 communicates with an application server 106 to retrieve and store necessary data in application server 106 to facilitate inspector's report submission. After the inspector completes inputting the inspection results and submits the report, copies of the completed report are distributed to various reviewers via a variety of Internet-based data delivery pathways, an email server 116, a facsimile gateway 124, and a Web page 126. The communications between IVSP server 104 and application server 106 may be accomplished using communications protocols capable of supporting voice-based interfacing such as the Voice Extensible Markup Language (VoXML). The IVSP server's Internet link may be provided by a VoXML Gateway and Browser 40.

The IVSP server 104 and the application server 106 are preferably implemented through a combination of one or more computing platforms, such as general or special purpose computers, and executable software code running on these. Each such computing platform is typically provided with hardware and/or ports to interface to at least one computer readable medium, such as a PROM, flash memory, CD-ROM, optical disk, hard drive disk, floppy disk or other non-volatile memory to store firmware and executable software code. The executable software code running on the various platforms may be updated from time by those having the authority to do so, and these updates can take place remotely over the internet or other communication channel. Each such computer will usually also have a second computer readable medium, such as associated RAM or other volatile memory to provide workspace for data and additional software.

IVSP server 104 preferably comprises a combination of hardware and associated software that facilitates input and review of quality control inspection information via a voice-based interactive user interface. The hardware and software are configured to collectively provide various functional components of IVSP server 104.

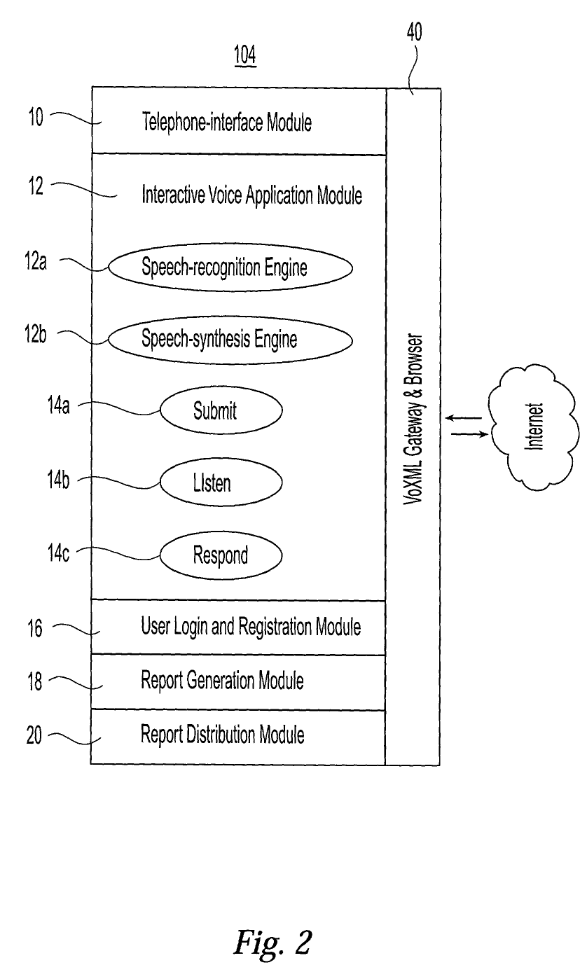

An example of these functional components of an IVSP server 104 is illustrated in FIG. 2. A telephone interface module 10 allows IVSP server 104 to interface with the telephone system so that calls from inspectors 105 may be received. An interactive voice application module 12 represents the software component of IVSP server 104 that enables IVSP server 104 to interact with inspectors 105 or reviewers. A user login and registration module 16 manages the limited-access feature of the voice reporting service center 103. A report generation module 18 instructs application server 106 to generate a formatted inspection report. Then a report distribution module 20 instructs application server 106 to distribute copies of the formatted inspection report to various reviewers 130 and/or notify the reviewers of the existence of a newly submitted report.

Interactive voice application module 12 may include two sub-components, a speech-recognition engine 12a and a speech-synthesis engine 12b that enable IVSP server 104 to hold interactive voice reporting sessions with callers 105 during which the caller may navigate through the session by inputting verbal commands or inputting information to be recorded and saved by IVSP server 104. Speech-recognition engine 12a is a software tool that enables IVSP server 104 to understand a caller's voice input. In other words, speech-recognition engine 12a enables IVSP server 104 to receive, recognize, and process the voice input from caller 105. When IVSP server 104 receives the caller's voice input, IVSP server 104 compares the received input against a library of voice data files, typically called Grammars, to decipher the voice input. A Grammar is essentially a collection of voice data representing the IVSP server's vocabulary. Grammars may be stored in application server 106. An example of a suitable speech-recognition engine is the speech-recognition engine available from Nuance Communications, Inc. of Menlo Park, Calif.

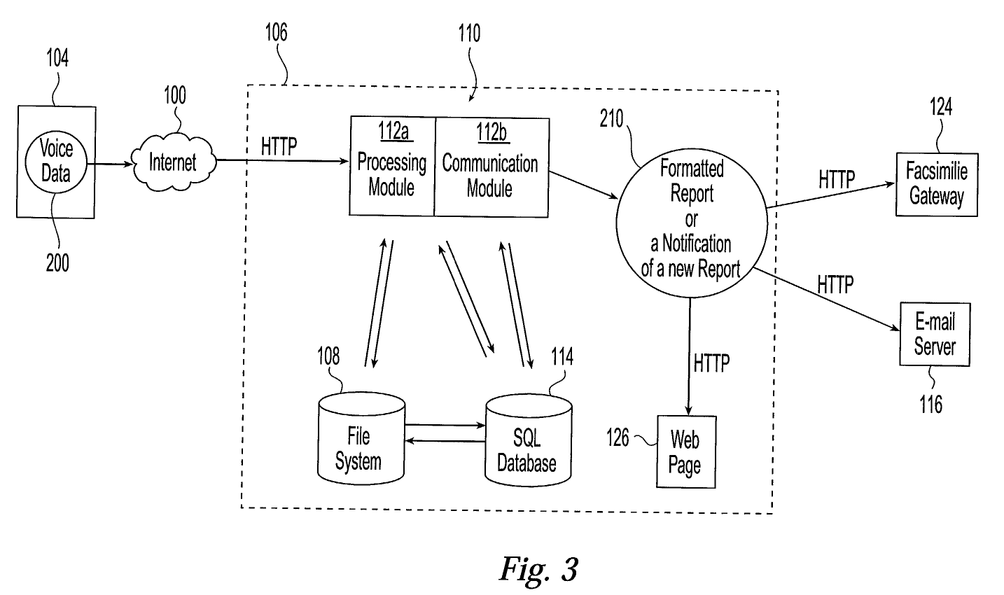

To enable IVSP server 104 to respond to caller 105 during a voice interactive session, IVSP server 104 may maintain a library of Audio files which are prerecorded words hat may be used by IVSP server 104. Audio files may be stored in application server's 106 file system 108 (see FIG. 3). As an alternative to or to be used in combination with the Audio files, IVSP server 104 may also utilize speech-synthesis engine 12b. Speech-synthesis engine 12b is a text-to-speech software tool that enables IVSP server 104 to synthesize select voice prompts when a prerecorded Audio file is not available for a particular voice prompt or response. An example of such software tool is the speech-synthesizer engine available from Lernout and Hauspie of England.

Interactive voice application module 12 may be a software application utilizing Web application communication protocols capable of supporting voice-based interfacing such as the VoXML to execute the above described data exchange operations with callers. During an interactive session with inspector 105, interactive voice application module 12 manages the IVSP server's three basic functions Submit 14a, Listen 14b, and Respond 14c using speech-recognition engine 12a and speech-synthesis engine 12b. A “Submit” command 14a is used to input information for a report, and this is done using an interactive voice reporting session and/or dual tone multi-frequency (DTMF) tones from the telephone keypad. The items to be reported may be entered in any order. Overall visit comments and individual item comments may be stored as audio data files in a relational database such as SQL database 114 associated with an application server 106, as discussed below. These audio data files may be in “.WAV” or other compressed audio file formats. The audio data files containing the inspection results are preferably stored in a relational database 114 because the data files or data segments need to be related individually to appropriate quality control items in the final inspection report that is to be generated from the data.

A “Listen” command 14b allows an inspector or a reviewer to listen to any report filed for a facility using a telephone. During the Listen mode, the user may navigate from item to item and report to report. Responding to a report may be done during the Listen process. Any number of comments may be left to respond to an inspection report.

Upon completion of the reporting session, a report generation module 18 instructs application server 106 to generate a formatted inspection report. Once a formatted inspection report is generated, report distribution module 20 instructs application server 106 to distribute copies of the formatted inspection report to various reviewers. Alternatively, the IVSP server 104 may be configured so that the report distribution module 20 may instruct application server 106 to distribute notifications of the existence of the new inspection report to reviewers rather than distributing the formatted inspection report itself.

IVSP server 104 also may include other functional modules that support other functions such as data caching and call profiling. A caller profiling module retrieves the basic profile information about the caller that has been previously saved on IVSP server 104. These caller profile data may include such information as the caller's address, phone number, and voice print data for identity authentication purposes. All application software and related components for each of the functional modules that are executed by application server 106 as discussed above may be maintained in file system 108 (FIG. 3). A suite of software tools for providing various functionalities of the voice-based interactive system such as VoXML, PERL Scripts, Java Classes, etc. may also reside on application server 106.

Preferably, voice reporting service center 103 has a controlled limited accessibility so that only those with authorization may access the system to either report the results of a quality control inspection or access the compiled reports. User login and registration module 16 manages this limited-access feature of the voice reporting service center 103. This module manages the login procedure at the beginning of a reporting session when an inspector 105 calls to submit an inspection report. This module may also allow a new inspector or a reviewer to register with the system to access IVSP server 104. For example, the system may be configured with user authorizations, logins and access rights so that inspectors may be authorized to report on a predetermined set of facilities only. Similarly, employees of one facility may be restricted from having access to reports submitted by inspectors about other facilities, even though both facilities may be commonly owned, operated or licensed.

In atypical voice reporting session, inspector 105 uses a telephone 102 and calls voice reporting service center 103 where an IVSP server 104 answers the call. IVSP server 104, through its speech recognition and synthesis engines 12a and 12b conducts an automated interactive voice reporting session during which inspector 105 inputs the results of a quality inspection as a voice input. As discussed above, the Audio files of responses that IVSP server 104 may use to respond to inspector's voice commands or requests during a voice reporting session may be stored in SQL database 114 in application server 106. The IVSP server would retrieve the proper Audio file from SQL database 114 to respond to the inspector. The inspector's voice input may be one or more predetermined command words in the Grammar data file or a quality inspection comment on a particular quality inspection parameter. The Inspector also may input a general comment directed to the overall aspect of the particular quality inspection visit.

The inspector's comments may be transmitted to application server 106 as a raw voice data and stored in application server 106 in the form of audio files such as “.WAV” or other compressed formats, in SQL database 114. As discussed above, these .WAV files may be retrieved by a caller during a report review session to listen to the comments. Application server 106 also converts the raw voice data into text-based data that also may be stored in SQL database 114 to be retrieved and converted into a formatted inspection report by application server 106.

The management of SQL database of data files and .WAV files such as adding, deleting, modifying, and packing of records may be accomplished by various Java™ servlets sent from IVSP server 104 to application server 106 where the SQL database reside. The SQL database may be any commercially available relational database management system such as those available from Microsoft, Oracle, or Sybase.

The formatted inspection report may then be distributed to various reviewers 130 through the Internet link 100 as an e-mail, via an e-mail server 116, as a facsimile transmission, via a facsimile gateway 124, or as a Web page 126. The e-mail transmission may be retrieved by the reviewer using a personal computer 128 or other Internet-capable mobile devices such as a mobile phone, a pager, a personal digital assistant (PDA) device, and the like, collectively shown as device 118. The facsimile transmission may also be received by the reviewer using a personal computer 128 or a standard facsimile machine 122. Web page report 126 containing the formatted inspection report may be established on application server 106, which also functions as a web server. The Web page may be retrieved by the reviewer using an Internet browser on a personal computer 128 or other Internet-capable mobile device 118. While the application server 106 is shown in FIG. 1 to be a single platform, it is understood that the application server may instead be a distributed entity.

Preferably, a report submitted by the inspector may be an “exceptions report” that only contains items that require attention. In other words, the inspector may report only on those items that fail to meet certain minimum quality standards among a predefined set of items or parameters important to ensure a desired level of quality for the operation of that facility. This limits the number of different voice inputs required and, thus, speech-recognition vocabulary required of the system may be kept to a reasonable number. Furthermore, this allows speaker-independent speech recognition to be achieved to some degree using commercially available off-the-shelf speech-recognition engines without the cost and expense associated with developing a custom speech recognition engine.

FIG. 3 illustrates a flowchart of the operation of application server 106. The raw voice data 200 entered by inspector 105 is transmitted by IVSP server 104 over the Internet 100 to application server 106. Application server 106 is a Web server that has been provided with an application specific software for receiving voice data and generating and distributing a particular formatted inspection report. The application software may utilize XML protocol since the Web server's operation involves exchange of data over the Internet.

The voice-based data 200 received from inspector 105 may be stored in the form of audio data files, such as “.WAV” or other compressed format, in SQL database 114. The audio data files may be played back to a reviewer accessing the report via a telephone and executing the interactive voice application module's Listen function. The audio data files may be made available to anyone accessing the formatted inspection reports using a Web browser and played back so that the reviewer may listen to the inspector's actual voice report.

Application server 106 may convert voice data 200 into text-based data that may be saved in SQL database 114. Application server 106 may include a software component 110 which may include, as a first component, a processing module 112a, that performs the data conversion. SQL database 114 is a software program responsible for long-term storage of structured data. It may be used to store users' account information, data associated with filed reports, and their statistics, and data used for generating valid responses to requests during the interactive voice reporting sessions with inspectors.

To convert the text-based data from SQL database 114 into a formatted inspection report, processing module 112a retrieves the formatting data stored in file system 108. The formatting data provides the layout of the inspection report so that processing module 112a may map the text-based data from SQL database 114 into the layout to generate a properly formatted inspection report 210. The formatted inspection report may also be stored in SQL database 114 in the formatted version to be retrieved subsequently or it may be reconstructed each time a copy of the report is required.

Software component 110 may also include, as a second component, a communication module 112b, for delivering copies of formatted inspection report 210 to various reviewers authorized to receive the report. Communication module 112b is configured so that copies of formatted inspection report 210 or a notification of the existence of a new report is distributed automatically and efficiently to various reviewers via Internet link 100. This provides maximum accessibility for the inspection reports by providing the reviewers with a variety of ways to access the inspection report. And by providing high accessibility for the inspection reports, the utility value of such quality control inspection reports is increased. The software component 110 may be stored and maintained in file system 108 as with other application software discussed above.

As discussed above with reference to FIGS. 1 and 2, a formatted inspection report 210 may be distributed to an authorized list of reviewers 130 through the Internet link 100 by utilizing one or more of various data delivery pathways, including an e-mail server 116, a facsimile gateway 124, and a browseable Web page 126. Formatted inspection report 210 may be distributed to a reviewer as a facsimile transmission utilizing a fax gateway 124 on the Internet.

Facsimile transmission gateway 124 is a software system that can receive e-mails and convert them in to facsimile transmissions. Application server 106 may send a formatted inspection report 210 along with a Java™ servlet containing the target facsimile device number to the facsimile transmission gateway 124. The facsimile transmission gateway would then send the formatted inspection report to target facsimile devices. A reviewer may request an additional facsimile to be sent to any facsimile device connected to a telephone line.

Formatted inspection report 210 may also be distributed to a reviewer as an e-mail through an e-mail server 116. If this option is selected, application server 106 may send the formatted inspection report information along with a Java™ servlet containing the target e-mail addresses to the e-mail server. The e-mail server would then send the formatted inspection report to the target e-mail addresses. The receiving reviewer may access the e-mail message using a Web browser on a personal computer 126 or on other e-mail or Web-capable wireless communication devices such as cell phones, pagers, personal digital assistants (PDA), etc. shown collectively as 118.

The formatted inspection report also may be distributed to one or more reviewers by placing a copy of the report on a designated Web site as a Web page 126. The Web page may be browsed by the reviewers using an appropriate Internet browser or an appropriate browser-based Web application software. In a preferred embodiment, Web page 126 may be configured to have a controlled-access so that only those with proper authorization to review the report may access and view the Web page. Reviewers may be required to provide a userid and a password to access the Web page. Once the browsing reviewer's access rights is verified, the reviewer may browse any reports filed in stores that they have authorization to view. If the reviewer's computer is equipped with speakers, the reviewer may listen to the inspection comments that are saved on the application server 106. Using the browser, the reviewer also may access other relevant information such as personal information, facility details, etc.

As an alternative, or as a complement to the report distribution routes described above, the system of the invention may send a notice of the existence of a new or an updated report to one or more authorized reviewers and/or inspectors. In those situations, the notice may provide information on how the recipient may retrieve the report. As with the distribution of the formatted inspection reports themselves, such notifications may also be distributed by the various distribution methods discussed above in reference to FIGS. 1 and 2. Such notification message, when sent as an e-mail or a Web page, may include a link to the new, or an updated, formatted report providing a uniform resource locator (URL), preferably in the form of a deep hyperlink, to an appropriate location on application server 106. A Java™ servlet can be sent out to all reviewers who subscribe to the store being reported. The servlet may include the date and time of the report, facility identification information, inspector information, and a reminder to the subscriber to call in and listen to the report. The subscribers/reviewers may pre-select the kinds of reports which they are to receive. Thus, for example, one may choose to track all reports filed by a particular inspector and, in such case, would receive notifications whenever that inspector files a report. This allows self administration as to who receives which notifications.

In response to such a notice, the receiving reviewer may use any Internet-capable device to access application server 106, present an appropriate userID and password, and/or other credentials, and then navigate their way to, or through, the Web site to obtain the report. The report may be viewed online, printed, or downloaded, as appropriate.

While a preferred embodiment is described with IVSP server 104 and application server 106 as two separate computer systems connected over the Internet link 100, it is not necessary that these servers be remotely located. They may be situated at a same location and connected by, for example, a Local Area Network. The functions of the two servers described may be performed by a single computer, where appropriate.

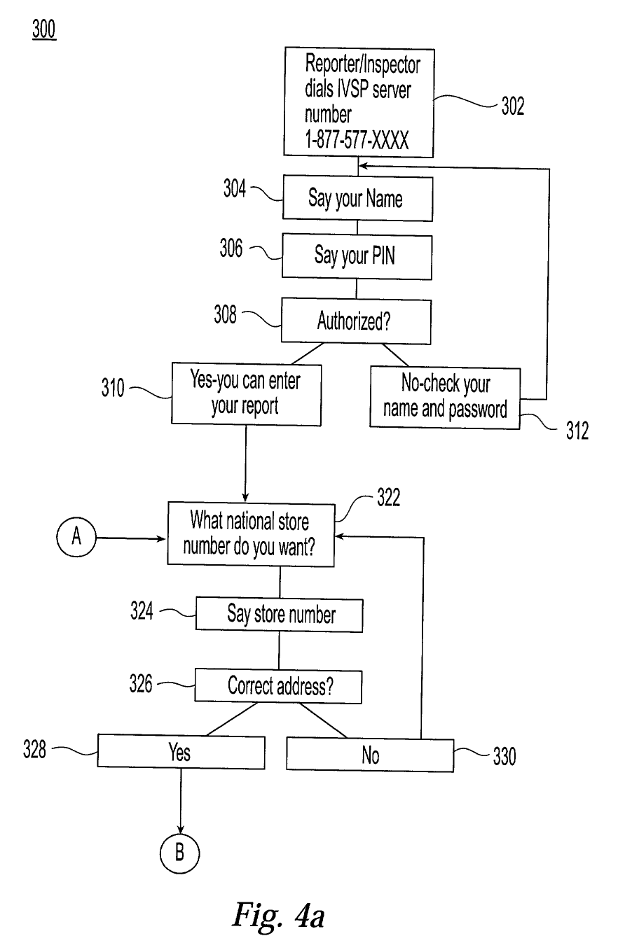

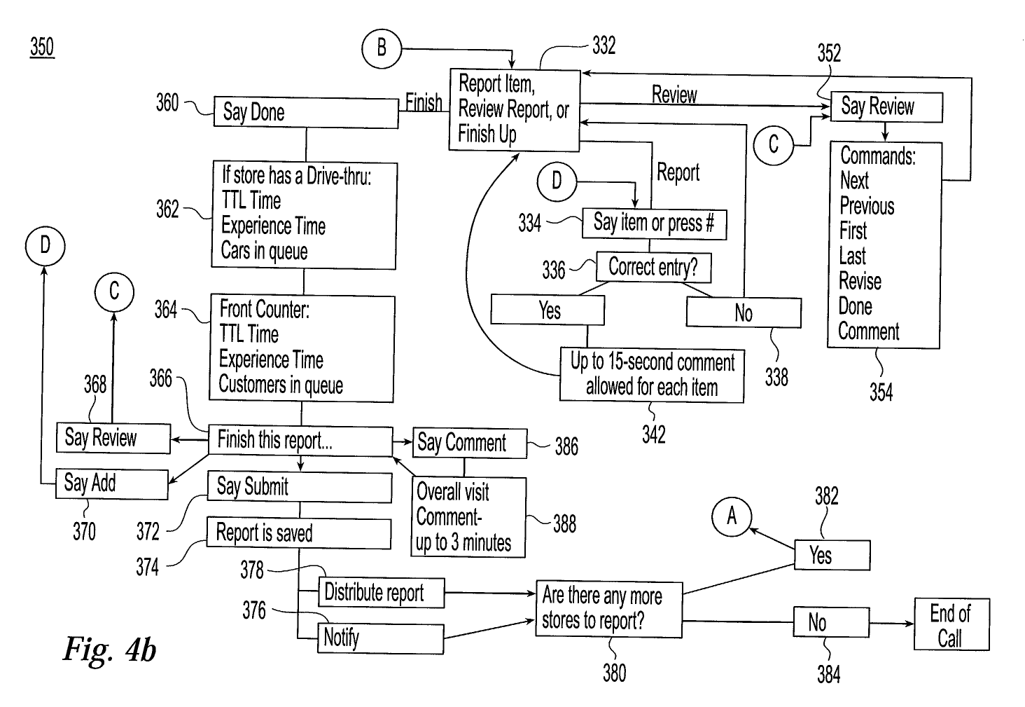

FIGS. 4a & 4b illustrate the process for submitting an inspection report in accordance with a preferred embodiment of the invention. FIG. 4a is a process flowchart 300 illustrating the login process steps for a preferred embodiment of the IVSP server. FIG. 4a also illustrates the initial steps to identify the facility being evaluated.

In step 302, an inspector calls the designated phone number for a voice reporting service center and in response to a voice prompt from the IVSP server's interactive voice application module 12, the inspector states his name 304 and a Personal Identification Number (PIN) 306 or a password. The IVSP server's user login and registration module 16 (see FIG. 2) then cross-references the received information against a database of authorized persons 308. If the caller is authorized to access the system, the caller is allowed to advance to next step 310 where new inspection results may be submitted or one or more inspection reports may be retrieved. If the caller's information does not match with any of the entry in the list of authorized persons 312, the system may prompt the caller to verify his name and PIN or password and to restate the information, if necessary. The user login and registration module may be configured to limit the number of retries allowed during a single phone call as a security measure. This type of security measure features are commonly found in many voice-interactive limited-access systems.

In steps 322-330, an inspector interacts with the system to identify the facility being inspected. In this example, the facilities involved are various store locations of a national franchise and each store location has an identifying number In step 322, the IVSP server prompts for the store number that has been inspected and in step 324, the inspector states the identification information for the particular facility on which he wishes to report. The IVSP server may confirm the store location information by reciting the street address 326 associated with the particular store number and require the inspector to confirm “yes” or “no”. If the answer is “no” 330 the IVSP server returns to step 322 and prompts the inspector for the store identification number again. If the address is correct and the inspector responds by “yes” 328, the IVSP server then continues with the remainder of the report.

FIG. 4b is a detailed process flowchart 350 illustrating the interaction between the system and the inspector, once the facility has been identified. It is understood that the flowchart 350 is illustrative for a particular type of facility—in this instance a fast food establishment. Other types of facilities may, of course, have other logic flows and options. In step 332, the system asks the inspector what he wishes to do. The options in this embodiment are to (a) report on a particular inspection item; (b) review the report or (c) finish up the report.

If, at step 332, the inspector wishes to report on a particular inspection item, in step 334, he or she may then identify the item by stating it or by pressing a particular key or a combination of keys corresponding to that item on the telephone. The IVSP server recites the entered information to confirm a correct entry 336. If the entry was incorrect and the inspector answers with “no” 338, the IVSP server loops back to step 332 and prompts again to see what the inspector wishes to do. If, on the other hand, the entry was correct and the inspector answers with “yes” 340, the inspector is prompted to report his comments on that particular inspection item 342. The system may be configured to set a time limit on the length of the comment that will be accepted and recorded at this step in an effort to manage the total amount of voice data that must be recorded and stored. In this example, a 15-second limit is illustrated 342. After the comment has been entered and recorded, the IVSP server loops back to step 332 to provide the inspector with the opportunity to report on another item.

If, at step 332, the inspector wishes to review the comments that he has entered during this reporting session, he would say “Review” 352. Then using a set of command words 354, he may review the entries, stepping through them by command words such as “Next”, “Previous”, “First” and “Last”. Upon hearing a particular entry, the inspector may make changes to the entry by invoking the command word “Revise”. The inspector may also use the command word “Comment” to further comment on a particular entry, in which the inspector is given a predetermined length of time, say, fifteen (15) seconds to comment and/or replace the last inspection report entry. Once the new comment has been entered, the IVSP server loops back to step 332.

If, at step 332 (or also at other instances during the reporting session), the inspector decides that he or she is finished reviewing the facility, and is ready to complete the particular reporting session, the inspector can say “Done” 360. The voice reporting system will then prompt the inspector for additional information required to complete the report. For example, if the particular facility has a drive-thru service window, the inspector will be prompted to enter information pertaining to the service quality of the drive-thru window, such as, the total time in line (TTL) time, the customer experience time, and the number of cars in queue, etc., as indicated in step 362.

The inspector may also be prompted to enter information pertaining to the service quality of a front counter 364. Examples of such information may be the TTL time, the customer experience time, and the number of customers in queue at the front counter.

After the front counter inspection information is entered, the IVSP server enters a “Finish the Report” state 366. At this point, the inspector may choose to enter an overall visit comment by saying “Comment” 386; review the report by saying “Review” 368; add additional report entries by saying “Add” 370; or submit the report by saying “Submit” 372. After any o

After entering the “Comment” command 386, the inspector would be allowed to enter a general comment about the overall visit that may not have been covered by the individual inspection items. Such overall visit comment would preferably be longer than the comments on each individual inspection items that were entered at step 342. In this example, three minutes is allowed for the overall visit comment 388.

After entering the “Review” command, the inspector may review any portion of the report. Once the system goes into the “Review” mode, the inspector may use the review commands used in the step 354 to review desired portions of the report. After entering the “Add” command 370, the inspector is taken by the IVSP server back to inspection item comment entry step 332, which allows the inspector to add new entries or make changes to the entries in the current inspection report. It should be noted here that invoking either the “Review” or “Add” command will ultimately require the inspector to say “Done” once again. However, since steps 362 and 364 have previously been executed, the system may be configured to bypass them the second (or subsequent) time around.

Eventually, the inspector will issue a “Submit” command 372. In such case, the newly entered inspection report is saved 374 in the application server's file system 108 (see FIG. 3).

Once a report is entered and submitted, the IVSP server's report distribution module 20 (see FIG. 2) may be configured to automatically notify reviewers of the newly entered report 376 or distribute formatted copies of the report itself 378 to various authorized reviewers via various communications methods discussed above in reference to FIGS. 1 and 2.

The system may then prompt 380 the inspector to ask whether there are any more facilities on which reports are to be made. If the answer is “yes” 382, the system goes back to the process step 322 shown in flowchart 300, so that the inspector may identify any such additional facility and begin the next report. If the answer is “no” 384, the system terminates the application and the call is ended.

It should be noted that a provision may be made to permit an inspector to cancel and stop a report at any time during any portion of this process by saying “Cancel.” In such case, the system will stop the inspection-reporting process described above and prompt the inspector whether there are any more facilities to report. The canceled report will not be recorded.

In general, the integrated voice service platform is configured to transmit a number of different types of voice prompts. Some request the caller to provide identifying information to identify the reviewer and the facility; others request the caller to identify which items are being reported on (and then interactively accept voice input about those items), and still others request information about specific items named by the IVSP. The following is a sample dialog illustrating an inspector submitting an inspection report to an IVSP server using voice inputs:

| | |
|---|---|
| IVSP: | “Welcome to the Q Reporter. Please say your name to |
| | login.” |
| INSPECTOR: | “John Doe” |
| IVSP: | “And the PIN for John Doe?” |
| INSPECTOR: | “One, two, three, four” |
| IVSP: | “Logging into server. You have been authorized to |
| | continue. What national store number are you reporting?” |
| INSPECTOR: | “Five, four, three, two, one” |
| IVSP: | “Store number five, four, three, two, one is located at |
| | four fifty Main Street, New York City. Is that correct?” |
| INSPECTOR: | “Yes“ |
| IVSP: | “What do you want to do? Create a new report or listen |
| | to an existing report? |
| INSPECTOR: | “Create a new report.” |
| IVSP: | “What do you want to report?” |
| INSPECTOR: | “Sandwich taste” |
| IVSP: | “Sandwich taste. Is that correct?” |
| INSPECTOR: | “Yes” |
| IVSP: | <A signal for the inspector to state his comment, such as |
| | a beep.> |
| INSPECTOR: | “The sandwich did not have any pickles on it.” |
| IVSP: | <A signal indicating the end of the comment, such as |
| | three beeps.> |
| | “Next item?” |
| INSPECTOR: | “Outside trash cans” |
| IVSP: | “Outside trash cans. Is that correct?” |
| INSPECTOR: | “Yes” |
| IVSP: | <one beep> |
| INSPECTOR: | “The trash cans were dumped over.” |
| IVSP: | <three beeps> |
| | “Next item?” |
| INSPECTOR: | “Done” |
| IVSP: | “The front counter TTL time?” |
| INSPECTOR: | “Ninety-five” |
| IVSP: | “Ninety-five seconds. Is that correct?” |
| INSPECTOR: | “Yes” |
| IVSP: | “Front counter experience time?” |
| INSPECTOR: | “One hundred and fifty-five” |
| IVSP: | “One hundred and fifty-five seconds. Is that correct?” |
| INSPECTOR: | “Yes” |
| IVSP: | “Customers in queue?” |
| INSPECTOR: | “Two” |
| IVSP: | “Two customers. Is that correct?” |
| INSPECTOR: | “Yes” |
| IVSP: | “OK. To finish this report, say Submit, Review, |
| | Comment (to leave overall visit comment up to three |
| | minutes), or Add” |
| INSPECTOR: | “Comment” |
| IVSP: | <one beep> |
| INSPECTOR: | “This was a great visit except for the Sandwich. Other |
| | than that, all looked great. Keep up the good work!” |
| IVSP: | <three beeps> |
| | “OK. To finish this report, say Submit, Review, |
| | Comment (to leave overall visit comment up to three |
| | minutes), or Add” |
| INSPECTOR: | “Submit” |
| IVSP: | “Your Q Report has been submitted. Are there any more |
| | store to report?” |
| INSPECTOR: | “No” (or just hang up the phone) |

Alternatively, the IVSP server may be configured so that the inspector may use the telephone keypad to enter commands. The following is a sample dialog illustrating an inspector submitting an inspection report to an IVSP server using a telephone keypad:

| | |
|---|---|
| IVSP: | “Welcome to the Q Reporter. Please say your name to |
| | login.” |
| INSPECTOR: | “John Doe” |
| IVSP: | “And the PIN for John Doe?” |
| INSPECTOR: | <enter “1234”> |
| IVSP: | “Logging into server. You have been authorized to |
| | continue. What national store number are you reporting?” |
| INSPECTOR: | <enter “54321”> |
| IVSP: | “Store number five, four, three, two, one is located at |
| | four fifty Main Street, New York City. Is that correct?” |
| INSPECTOR: | <enter “1” which is a preassigned numeric code for “yes” |
| | to any question> |
| IVSP: | “What do you want to report?” |
| INSPECTOR: | <enter “3” which is a preassigned numeric code for |
| | “Sandwich taste”> |
| IVSP: | “Sandwich taste. Is that correct?” |
| INSPECTOR: | <enter “1”> |
| IVSP: | <one beep> |
| INSPECTOR: | “The sandwich did not have any pickles on it.” |
| IVSP: | <three beeps indicating the end of the comment> |
| | “Next item?” |
| INSPECTOR: | <enter “23” which is a preassigned numeric code for |
| | “outside trash cans”> |
| IVSP: | “Outside trash cans. Is that correct?” |
| INSPECTOR: | <enter “1”> |
| IVSP: | <one beep> |
| INSPECTOR: | “The trash cans were dumped over.” |
| IVSP: | <three beeps> |
| | “Next item?” |
| INSPECTOR: | <enter “99” which is a preassigned numeric code for |
| | “done”> |
| IVSP: | “The front counter TTL time?” |
| INSPECTOR: | <enter “95”> |
| IVSP: | “95 seconds. Is that correct?” |
| INSPECTOR: | <enter “1”> |
| IVSP: | “Front counter experience time?” |
| INSPECTOR: | <enter “155”> |
| IVSP: | “155 seconds. Is that correct?” |
| INSPECTOR: | <enter “1”> |
| IVSP: | “Customers in queue?” |
| INSPECTOR: | <enter “2”> |
| IVSP: | “2 customers. Is that correct?” |
| INSPECTOR: | <enter “1”> |
| IVSP: | “OK. To finish this report, say Submit, Review, |
| | Comment (to leave overall visit comment up to three |
| | minutes), or Add” |
| INSPECTOR: | “Comment” |
| IVSP: | <one beep> |
| INSPECTOR: | “This was a great visit except for the Sandwich. Other |
| | than that, all looked great. Keep up the good work!” |
| IVSP: | <three beeps> |
| | “OK. To finish this report, say Submit, Review, |
| | Comment (to leave overall visit comment up to three |
| | minutes), or Add” |
| INSPECTOR: | <enter “1”> |
| IVSP: | “Your Q Report has been submitted. Are there any more |
| | store to report?” |
| INSPECTOR: | <enter “2” (or just hang up the phone)> |

And as discussed above, once an inspector enters and submits an inspection report via the IVSP server, the information is saved in a relational database 114 and may be retrieved via interactive voice activation module 12. A copy of a formatted inspection report also may be made available on the Internet as a Web page and may be viewed using an Internet browser based Web application.

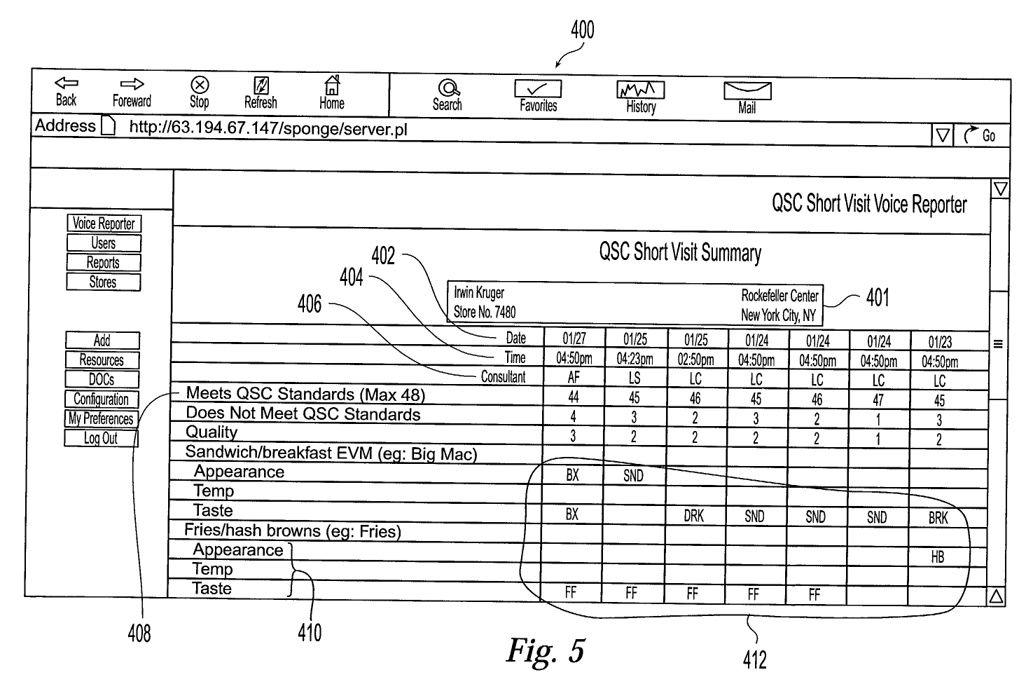

FIG. 5 illustrates an exemplary inspection report 400 generated by the IVSP server in accordance with a preferred embodiment of the present invention displayed through an Internet browser. This exemplary composite inspection report is a compilation of multiple inspection reports. In this instance, the facility identifying information 401 identifies this facility as a fast food restaurant designated Store No. 7480 and it presents results of seven different inspections. The report presents the results of each inspection visit in a column format. Each inspection report identifies the date 402 and time 404 of each inspection visit and the inspector 406 (labeled on the report as “Consultant”) who reported the results.

Each inspection report may include overall inspection information such as an overall quality standard value 408 rated by the inspector. It may list individual inspection items 410 and shorthand representations 412 of the inspector's comment for each inspection item. It is to be appreciated by one skilled in the art that the format of a report may be customized for a particular type of facilities being inspected and the particular format of the quality control inspections involved.

As discussed above, a reviewer may access formatted inspection report 400 using an Internet browser. Alternatively, a customized browser-based Web application, Reviewer Web Client, can be used by authorized users to see and listen to any report in the voice-based interactive system over the Internet using a personal computer. In addition, a different customized browser based Web application, Administration Web Client, may be provided to the administrators of the voice-based interactive system to access IVSP server 104 and application server 106 and manage various aspects of the voice-based interactive system. Using the Administration Web Client, an administrator may access and control all aspects of the system including user login and registration module 16, report generation module 18, and report distribution module 20.

While the present invention has been described with reference to a few specific embodiments, the description is illustrative of the invention and not to be construed as limiting the invention. Various modifications may occur to those skilled in the art without departing from the true spirit and scope of the invention as defined by the appended claims.

What is claimed is:

1. A computer-assisted system for collecting and distributing quality control inspection information comprising:
an integrated voice services server configured to receive quality control inspection information in raw voice data form telephonically provided by at least one inspector; and
an application server configured to:
convert said raw voice data into text-based data;
generate an inspection report from said text-based data, and
distribute said inspection report over the Internet.

2. The computer-assisted system according to claim 1, wherein said application server is configured to distribute said inspection report by one or more of:
an e-mail transmission through an e-mail server;
a facsimile transmission through a facsimile gateway, and
transmission of at least one Web page.

3. The computer-assisted system according to claim 1, wherein said application server is configured to transmit a notification that an inspection report has recently been generated, along with information identifying one or more of:
at least one facility covered in the report; and
the inspector who provided inspection information for that report.

4. The computer-assisted system according to claim 3, wherein said facility belongs to a franchise in a food services industry, and said inspection report is sent to a representative of a corresponding franchiser.

5. The computer-assisted system according to claim 1, wherein said application server is configured to transmit at least a portion of the raw voice data, in response to a request received from at least one Web page.

6. The computer-assisted system according to claim 1, wherein the integrated voice services platform is configured to:
transmit a first voice prompt requesting facility identification information; and
transmit at least one second voice prompt requesting information identifying an item about which the inspector wishes to report.

7. The computer-assisted system according to claim 6, wherein the integrated voice services platform is further configured to transmit at least one third voice prompt requesting information about specific items.

8. The computer-assisted system according to claim 6, wherein the integrated voice services platform is further configured to receive voice responses in response to at least some of said voice prompts.

9. The computer-assisted system according to claim 6, wherein the integrated voice services platform is further configured to receive telephone keypad input in response to at least some of said voice prompts.

10. A computer-assisted method of collecting and distributing quality control inspection information, the method comprising:
telephonically receiving quality control inspection information in raw voice data form;
storing said raw voice data;
converting said raw voice data into text-based data;
generating an inspection report from said text-based data; and
distributing said inspection report over the internet.

11. The computer-assisted method according to claim 10, wherein the report is distributed by one or more of:
an e-mail transmission through an e-mail server;
a facsimile transmission through a facsimile gateway, and
transmission of at least one Web page.

12. The computer-assisted method according to claim 10, comprising the step of transmitting a notification that an inspection report has recently been generated, along with information identifying one or more of:
at least one facility covered in the report; and
an inspector who provided inspection information for that report, prior to the step of distributing the report over the internet.

13. The computer-assisted method according to claim 12, comprising the step of transmitting information identifying a franchise store in a food services industry, the franchise store being the facility that has been inspected.

14. The computer-assisted method according to claim 10, comprising the step of transmitting at least a portion of the raw voice data, in response to a request received from at least one Web page.

15. The computer-assisted method according to claim 10, comprising the steps of:
transmitting a first voice prompt requesting facility identification information; and
transmitting at least one second voice prompt requesting information identifying an item about which quality control inspection information is to be received.

16. The computer-assisted method according to claim 15, comprising the step of transmitting at least one third voice prompt requesting information about specific items, after the step of transmitting said first voice prompt.

17. The computer-assisted method according to claim 15, comprising the step of receiving voice responses in response to at least some of said voice prompts.

18. The computer-assisted method according to claim 15, comprising the step of receiving telephone keypad input in response to at least some of said voice prompts.

19. A computer readable memory having executable software code stored thereon, the code comprising code to collect quality control inspection information including:
code to telephonically receive quality control inspection information in raw voice data form;
code to store said raw voice data;
code to transmit a first voice prompt requesting facility identification information;
code to transmit at least one second voice prompt requesting information identifying an item about which quality control inspection information is to be received; and
code to transmit at least one third voice prompt requesting information about specific items, the code to transmit at least one third voice prompt arranged to be executed after the code to transmit the voice prompt.

20. The computer readable memory according to claim 19, further comprising:
code to receive telephone keypad input, said code to receive telephone keypad input arranged to be executed after at least some of the code to transmit voice prompts.

21. A computer readable memory having executable software code stored thereon, the code comprising code to process and distribute quality control inspection information originally received as raw voice data, the code including:
code to convert said raw voice data into text-based data;
code to generate an inspection report from said text-based data; and
code to transmit a notification that an inspection report has been generated, along with information identifying one or more of:
a franchise store in a food services industry which the inspection report is about; and
an inspector who provided inspection information for that report, prior to the step of distributing the report over the internet; and
code to distribute said inspection report over the internet.

22. The computer readable memory according to claim 21, further comprising:
code to transmit at least a portion of the raw voice data, in response to a request received from at least one Web page.
